(19) United States
(12) Patent Application Publication
(10) Pub. No.: US 2019/0156621 A1
(43) Pub. Date: May 23, 2019

(54) GAMING APPARATUS AND METHODS OF PROVIDING GAMING SOLUTIONS

(71) Applicant: Takara Gaming Solutions Limited, Hong Kong (HK)

(72) Inventor: Ka Lun Ernie Suek, Hong Kong (HK)

(21) Appl. No.: 16/195,843

(22) Filed: Nov. 19, 2018

(30) Foreign Application Priority Data
Nov. 17, 2017 (HK) 17112074.5

(51) Int. Cl. G07F 17/32

(52) U.S. Cl. CPC G07F 17/3225; G07F 17/3209; G07F 17/3258; G07F 17/3213; G07F 17/3244; G07F 17/3211

(57) ABSTRACT

A computer-controller gaming apparatus comprises a computer-controlled platform which is to execute stored instructions to integrate modular game components and to run a computer-controlled game. The game modules comprise component modules including a control module and a contents module, and the modules contains essential communication interfaces to facilitate inter-module data communication so that a game can be constructed from essential modules, with the essential modules containing no reference to identification of the component modules.

### RELATED APPLICATIONS

The present application claims priority to patent application number 17112074.5 of Hong Kong SAR, China, filed on Nov. 17, 2017.

### BACKGROUND

Gaming machines such as pin-ball machines, card machines, slot machines, video machines, war game machines, fish-catching game machines, etc., provide great entertainment and useful utilities and are beneficial to the public. Computer-controlled gaming machines, especially computer-controlled floor-standing machines, are becoming main stream due to their great performance, sophistication and flexibility.

Computer-controlled gaming machines require cooperation of many game components and administration components to function, operate, and perform.

It would be advantageous and beneficial if game and administration components of computer-controlled gaming machines from different sources can be combined from time to time to provide more choices to the public.

### DISCLOSURE

A computer-controller gaming apparatus comprises a computer-controlled platform which is to execute stored instructions to integrate modular game components and to run a computer-controlled game. The game modules comprise component modules including a control module and a contents module, and the modules contains essential communication interfaces to facilitate inter-module data communication so that a game can be constructed from essential modules, with the essential modules containing no reference to identification of the component modules.

A gaming apparatus comprising a controller is disclosed. The apparatus comprises a video display device, a user control interface device, a data storage device and a communication frontend device; wherein the controller is to execute stored instructions to devise a scene or a series of scenes on the video display device to invite a user to act or react, and the user is to act or react by operating the user control interface device to send a responsive signal or responsive signals to the controller; wherein the controller is to detect and process the responsive signal and to evaluate responsive performance of the user based on the received responsive signal and the stored instructions; wherein the stored instructions are resident in a first module which is control module, and data for forming the scene are resident in a second module which is a contents module; and wherein the controller is to communicate with the control module to execute the stored instructions and to communicate with the contents module to obtain data for forming the scene, and wherein the controller is to communicate with the contents module through the control module as a necessary intermediary.

The first module may comprise a logic portion, and the logic portion contains stored instructions defining rules for detecting and evaluating a received responsive signal, and rules for evaluating responsive performance based on the received responsive signal and the stored instructions.

The logic portion may comprise instructions defining rules of game flow and game logic, wherein the game logic comprises instructions defining game flow and instructions defining possible outcomes on reaching a specific stage or on receiving a responsive signal.

The first module may comprise a math portion, and the math portion contains instructions defining mathematical relations associated with the game flow and game logic.

The second module may comprise instructions to facilitate generation of human perceivable signals for delivery to a machine-user interface for perception by a user operating the user control interface device, the machine-user interface including the video display device.

The second module may comprise second module comprises stored instruction files, data files and data links, wherein the controller is to access the data files and or the data links to form the human perceivable signals and to deliver the human perceivable signals to the machine-user interfacing device.

The controller is to access the data files and the data links through instructions stored in the first module, and wherein the data files contain data for forming animated graphical scenes and signs.

The controller is to execute the instruction files in the second module to generate human perceivable signals, and wherein the controller is to send instructions to the first module to execute the instruction files stored in the second module.

In some embodiments, the first module and the second module are to communicate using a first type of communication protocol and the controller and the first module are to communicate using a second type of communication protocol different to the first type.

In some embodiments, the first module is one of a plurality of control modules stored in the data storage device, and the second module is one of a plurality of contents modules stored in the data storage device; and wherein the controller is to select the first module from the plurality of control modules, to select the second module from the plurality of contents modules, to connect the first module and the second module, and to execute instructions stored in the first module to run a computer-controlled game.

In some embodiments, one or a plurality of control modules or game engines is store in the non-volatile memories of the apparatus for selection by the controller according to platform instructions.

In some embodiments, one or a plurality of contents modules or game engines is store in the non-volatile memories of the apparatus for selection by the controller according to platform instructions.

The controller is to execute stored platform instructions to select the first module from the plurality of control modules, to select the second module from the plurality of contents modules, and to connect the first module and the second module; and wherein the stored instructions are contained in a platform module which is not part of the first module.

In some embodiments, the first module comprises a plurality of essential communication interfaces for facilitating essential communication with the second module and the controller, wherein the second module comprises a plurality of essential communication interfaces for facilitating essential communication with the first module; and wherein the essential communication interfaces are to facilitate inter-module data communications.

The example communication ports of the Game Server are example of essential communication interfaces of the second module.

The example communication ports of the UI module are example essential communication interfaces of the second module.

In some embodiments, the first module is to send a first type and a second type of messages, the first type being an instruction-type message for sending to the second module, and the second type being a feedback-type message for sending to the controller.

In some embodiments, the second module is to send a feedback-type message to the first module to acknowledge receipt of an instruction-type message from the first module.

In some embodiments, the controller is to send a first type and a second type of messages, the first type being an instruction-type message for sending to the first module, and the second type being a feedback-type message for sending to the first module.

In some embodiments, the first module is identifiable has a first identification and the second module has a second identification, and wherein the first module contains no reference to the second identification and the second module contains no reference to the first identification.

In some embodiments, the second module comprises instructions to facilitate generation of human perceivable signals for delivery to a machine-user interface as human perceivable information for perception by a user operating the user control interface device, the machine-user interface including the video display device; wherein the controller on execution of stored instructions of the first module are to generate a set of human perceivable data; and wherein the second module is to output the human perceivable data and to superimpose the human perceivable data on the human perceivable information.

A method of operating a computer-based gaming machine is disclosed.

The machine comprises a controller, a video display device, a user control interface device, a data storage device and a communication frontend device; wherein the method comprises the controller executing stored instructions to install a first module and a second module on the data storage device, to connect the first and second modules to form a set of game instructions, and to execute the set of game instructions; wherein the game instructions are resident in the first module which is control module, and data for forming the scene are resident in the second module which is a contents module.

The method comprises the controller executing stored instructions to communicate with the control module to execute the stored instructions, and to communicate with the contents module to obtain data for forming the scene, and wherein the controller is to communicate with the contents module through the control module as a necessary intermediary.

The method further comprises the controller executing the game instructions: to devise a scene or a series of scenes on the video display device to invite a user to act or react, to receive responsive signal or responsive signals, to process received responsive signal or receive responsive signals, and to evaluate responsive performance based on the received responsive signal or the receive responsive signals and the stored instructions, the responsive signal or responsive signals being sent by the user control interface device to the controller.

The method further includes processed corresponding to the afore-said apparatus components.

### FIGURES

The present disclosure and example embodiments thereof are described by way of example and with reference to the accompanying Figures, in which:

FIG. 1 is a block diagram of a computer-controller gaming machine of the present disclosure,

FIG. 1A is a block diagram of the gaming machine of FIG. 1 showing more sub-components, including components of the main controller, components of the interfaces and modular components,

FIG. 2 is a block diagram of game components forming a game engine,

FIG. 2A is a block diagram showing components of a computer-executable game and associated communication interfaces,

FIGS. 2B and 2C are block diagrams of a game module and a library module,

FIG. 3A is a block diagram of an example floor-standing gaming machine of FIG. 3B,

FIG. 3C is a block diagram showing details of some component of the machine of FIG. 3A,

FIG. 3D shows example layout of a screen display of the machine of FIG. 3B, and

FIGS. 4A, 4B, 4C1, 4C2, 4D and 4E are example flow diagrams showing, in particular, message flow among the Platform, the Game Server and the UI module.

### DESCRIPTION

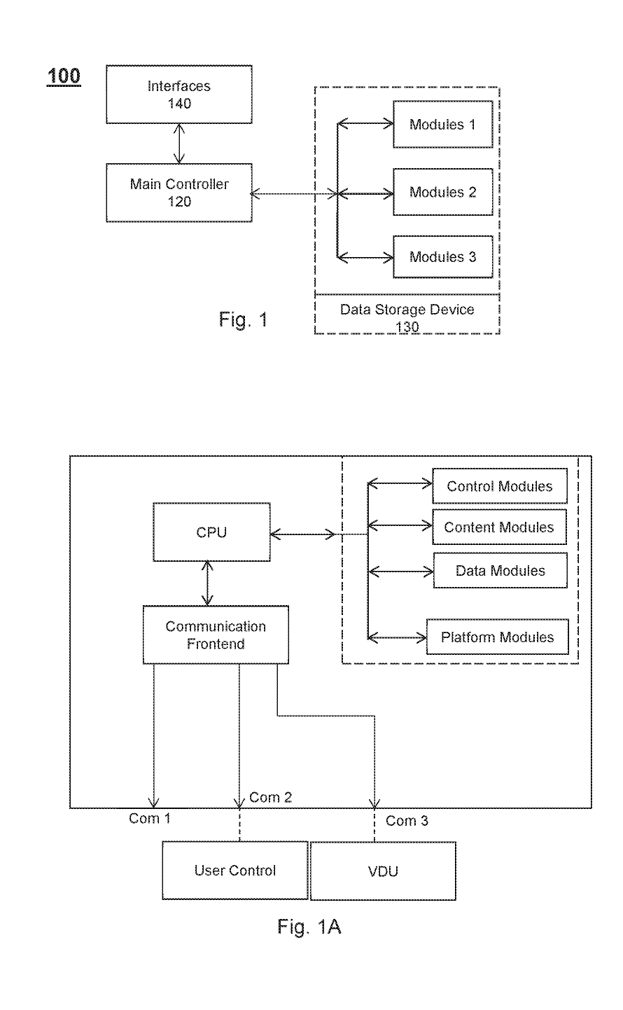

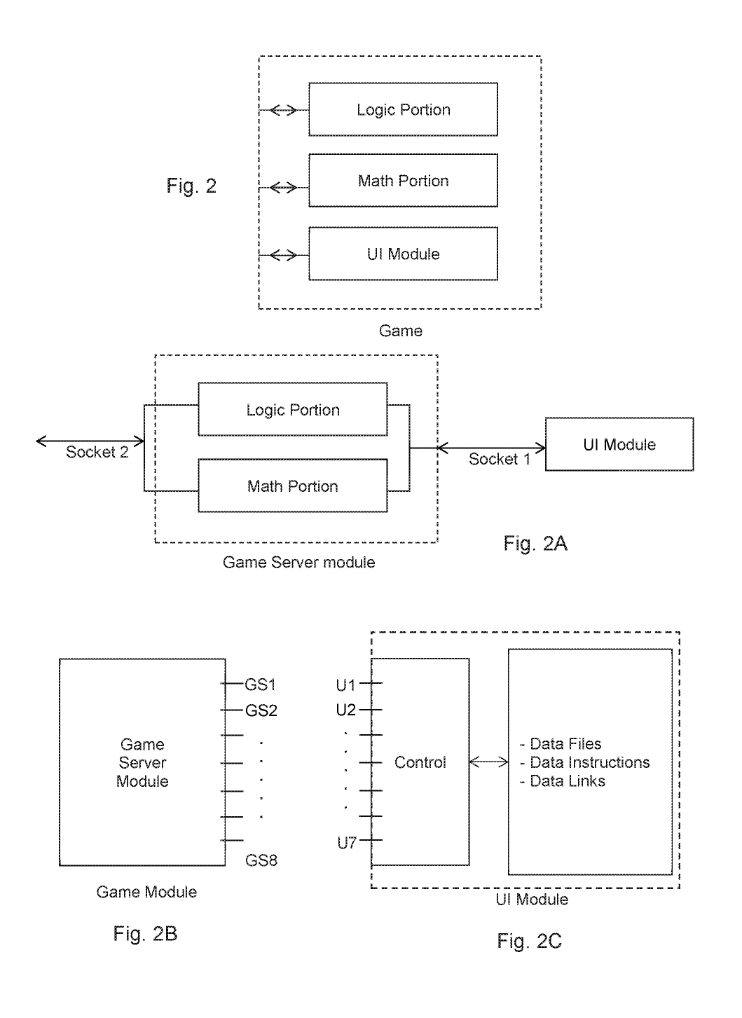

A machine for gaming applications comprises a main controller 120, a data storage device 130 and one or a plurality of interfaces 140, as depicted in FIG. 1. The main controller is a computer-based machine controller (or “controller” in short) which is to execute stored operation instructions to operate and control operations of the machine 100. The machine typically comprises a microprocessor (CPU) or a cluster of CPUs on a micro-processor-based circuit board as an example of a computer-based controller. The machine may comprise an FPGA (field programmable logic array) controller and the FPGA controller may be used in combination with or as an alternative to a microprocessor to form a computer-based controller. The interfaces comprise control and communication interfaces, which include, for example, machine-to-user interfaces, user-to-machine interfaces and machine-to-machine interfaces. The data storage device is for storing data and instructions and the main controller is to use the stored data and instructions to execute a process according to pre-stored instructions.

An example machine 100 is a computer-based machine comprising a main controller, a video display, a data storage device and a user control interface, as depicted in FIG. 1A. The main controller comprises a microprocessor-mounted printed circuit board (“main control board”) and a communication frontend having a plurality of data communication ports (Com1, Com 2, Com 3). The communication frontend is for facilitating data communication with peripheral devices of the machine and for facilitating data communication with external networks or devices, which are not part of the machine. The communication frontend may be an integral part of the main control board or may be formed as a separate circuit module.

The example communication frontend comprises an example plurality of three communication ports, namely, Com 1, Com 2 and Com 3. The example communication ports Com 2 is a network port for facilitating external data communication, for example with a LAN, WLAN and/or the Internet. The example communication ports Com 2, Com 3 are to facilitate data communication with peripheral devices such as the video display and the user control interface. The video display is an example of machine-to-user interfaces which is to provide audio and visual effects to a user and may comprise a video display unit (VDU) including an LCD display panel and audio speakers. The user control interface device is an example of user-to-machine interfaces which is to provide means for a user to send user instructions or user responsive signals to the machine. An example user control interface device may comprise buttons, knobs, joysticks, triggers, driving wheels, or their combination. In some embodiments, the VDU may be a touch panel to also serve as a user control interface device or part thereof. The video display and the user control interface device cooperate to provide means to facilitate human-machine interaction. The data storage device comprises a combination of volatile and non-volatile memories. The volatile memories typically comprise solid state memories such as random-access memories (RAM). The non-volatile memories may include read-only memories (ROM) and hard drives such as solid-state hard drives or hard disks. The example machine 100 is a floor-standing gaming machine and comprises a rigid floor-standing main housing. The components of the machine are held on the rigid main housing, with the display screen exposed through a window and the user control interface exposed to permit physical access of a user. In some embodiments, the machine controller and the other components are on different or separate housings and are interconnected by communication links, for example wired or wireless communication links. The machine may be a desktop or a handheld gaming machine in some embodiments. The communication port Com 1 is an example of machine-to-machine interfaces to facilitate inter-machine data communication.

The machine 100 is a computer-based machine which is to function as a gaming machine for running software-based games (or “games” in short). The games to be run by the machine 100 include one which is formed from post-connection or post-assembly of software-based game components (“game components” in short) of different sources. A game which is formed by post-connection or post-assembly of game components herein means a game comprising a plurality of game components and the game components are linked, connected or assembled after being resident on the machine, but are not linked, not connected or not assembled prior to residing on the machine. The game components are not linked, not connected or assembled prior to being resident on the machine includes the meaning that the game components are not interlinked, inter-referenced, interconnected or not assembled together prior to being resident on the machine 100. The post-connected or post-assembled game components are only linked, connected or assembled after the controller begins to run the game after receipt of instructions to commence operation of the game.

In order that the controller is to rum a game from game components which are not prior linked or prior connected, the game components would need to be able to communicate with each other during game execution when gaming instructions are executed by the controller, so that functions embedded in the game components can be duly utilized by the controller during game execution. Game components not prior linked or prior connected herein includes the meaning that the game components are not interlinked or interconnected prior to execution of gaming instructions, which are the instructions to command the controller to commence execution of the gaming process.

To meet the above said objectives, the controller is configured to execute stored instructions to link or integrate the game components at the time of execution of the gaming process and after receipt of instructions to commence operation of the game.

In example embodiments, the game components are delivered as modular components by different vendors and are loaded to resident on the data storage device of the machine, as depicted in FIGS. 1 and 1A. For example, game component modules are loaded to resident on the hard disk of the machine prior to commencement of the game so that the modules are game component are resident on the machine prior to commencement of game operations. When the game is to commence, the controller will execute a set of stored instructions to then load the gaming instructions to be resident in the volatile memories, to connect the game components, and then to execute the gaming instructions. This set of stored instructions to facilitate interconnection and subsequent execution of the game components is part of a set of instructions which is referred to as “platform instructions” herein, and the machine 100 when executing the platform instructions is referred to herein as a “Platform” or a “game Platform”. The platform instructions are to facilitate the machine 100 to function as a general-purpose gaming apparatus which is operable to connect modular game components of a specific game and to execute instructions stored in the modular game components.

In order that the machine 100 is to operate as a general-purpose gaming apparatus which is capable of performing additional tasks of performing specific gaming operations using game components of different vendors or sources, the machine according to the disclosure is devised to function and operate as a general-purpose gaming platform. The Platform is equipped with platform capabilities to execute platform instructions to connect game components and to execute instructions embedded in the game components. The game components may comprise game vertical components or horizontal components. Vertical components are to be connected vertically and horizontal components are to be connected horizontally during execution of the gaming instructions.

To facilitate operation as a game platform, the machine may run on a general-purpose computer operating system of a conventional computer-based gaming machine and to execute platform instructions to devise the platform. The general-purposes computer operating systems which are currently available are, for example, Windows® or Linux® operating systems.

To facilitate operation as a gaming machine of a specific game, the platform is to load a set of game instructions of the specific game and execute the gaming instructions of the specific game. After game instructions have been loaded, the controller 120 is ready to commence running of the game upon receipt of a commencement instruction from a user, through a user control interface.

After a specific game has been commenced by the controller 120, and during a game session of the specific game, the controller 120 is to execute stored instructions to perform specific machine functions of a specific game controller using instructions embedded in the individual game components.

Example machine functions of a game controller include providing informative signals to attract a user to interact with the machine, detecting responses of a user responsive to the invitation, evaluating responses of the user, and determine the outcome and/or the next event according to a set of stored instructions. The outcome may be start of a game with a user. If a game has started, the outcome may be whether a user has achieved a score, has reached a level or phase, is to receive a reward, no reward, or negative reward, the next event, the next phase or the next level.

During the course of the gaming process, the machine controller is to facilitate communication of various human perceivable information to the user. The human perceivable information is typically devised with an intention to invite a user to participate in a game, to invite a user to make a response when a game has started, to provide a feedback or echo on the response made by the user, to keep the user informed of developments of the gaming process, to provide visual information to make the interaction more attractive to a user, and/or to invite the user to make further responses or further interactions. The interaction may be between the machine and a single user or a plurality of users, depending on whether the stored instructions are designed for multiple-user interactions.

A game comprises a logic portion and a math portion. The logic portion provides rules to define the process flow and the process logic of the game. The process flow defines events and situations that will occur during the course of a game, as well as their sequence of occurrence and/or their timing of occurrence, or other flow parameters. The logic portion comprises decision mechanisms for making decisions upon occurrence of an event or a situation, rules on probability of occurrence of an event or a situation, other flow logic parameters, as well as output of decision outcomes. The math portion comprises mathematical rules and parameters in relation to a logic event. For example, the math portion may include the probabilities associated with each one of a plurality of possible outcomes in a logic event, the reward rate associated with each possible outcome, bonus rate, arithmetic rules, rules for generating probability and other mathematical rules. The various rules are stored in the form of computer-readable instructions suitable and readily available for execution by a computer without loss of generality.

For example, the logic portion may include computer-readable instructions which define the sequential flow of game events, available possible or alternative events or situations to progress in response to specific responsive signals provided by a user, and other flow logics in the form of computer-readable instructions.

In example embodiments such as the present, a game comprises a first module and a second module, as depicted in FIGS. 1 and 1A. The first module is a control module which comprises the logic portion and the math portion, and is also referred to as a game server module (“Game Server”). The second module is a contents module which comprises a plurality of documentations for user interfacing, and is also referred to as an UI module. Each of the first and second modules is a module comprising computer-readable instructions which are executable by a computer. Each of the modules comprises a plurality of communication interfaces to facilitate inter-module or module-and-platform communications.

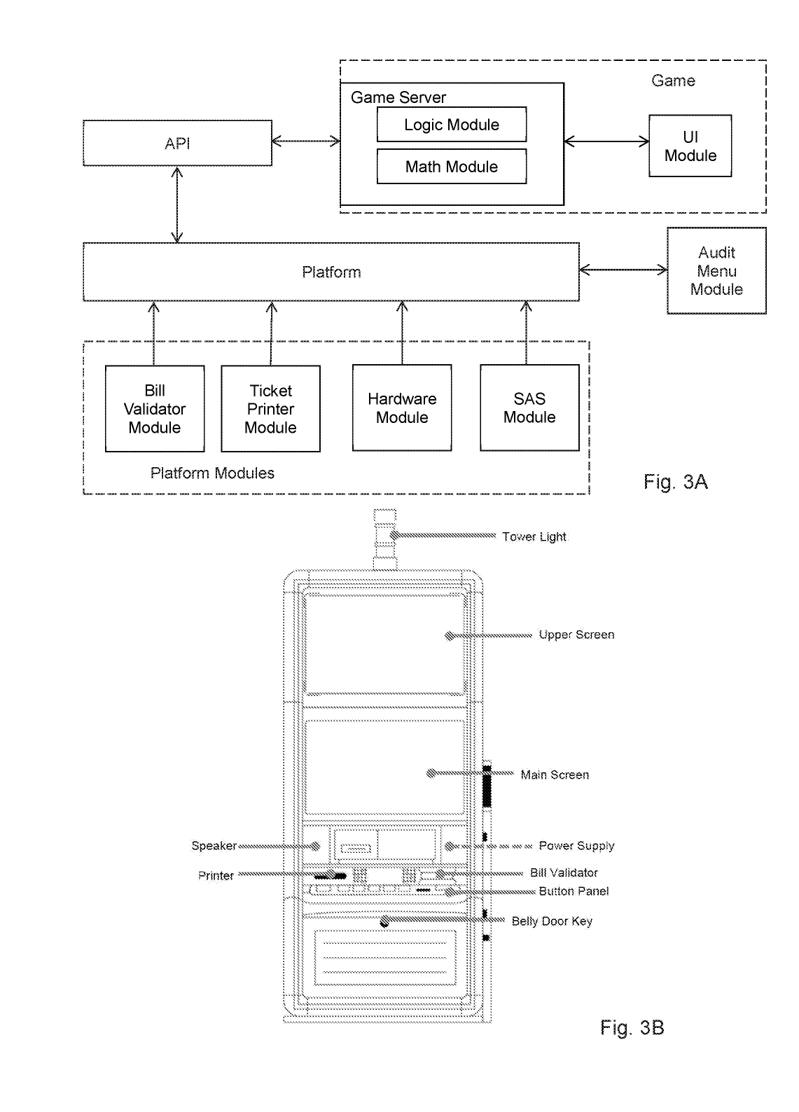

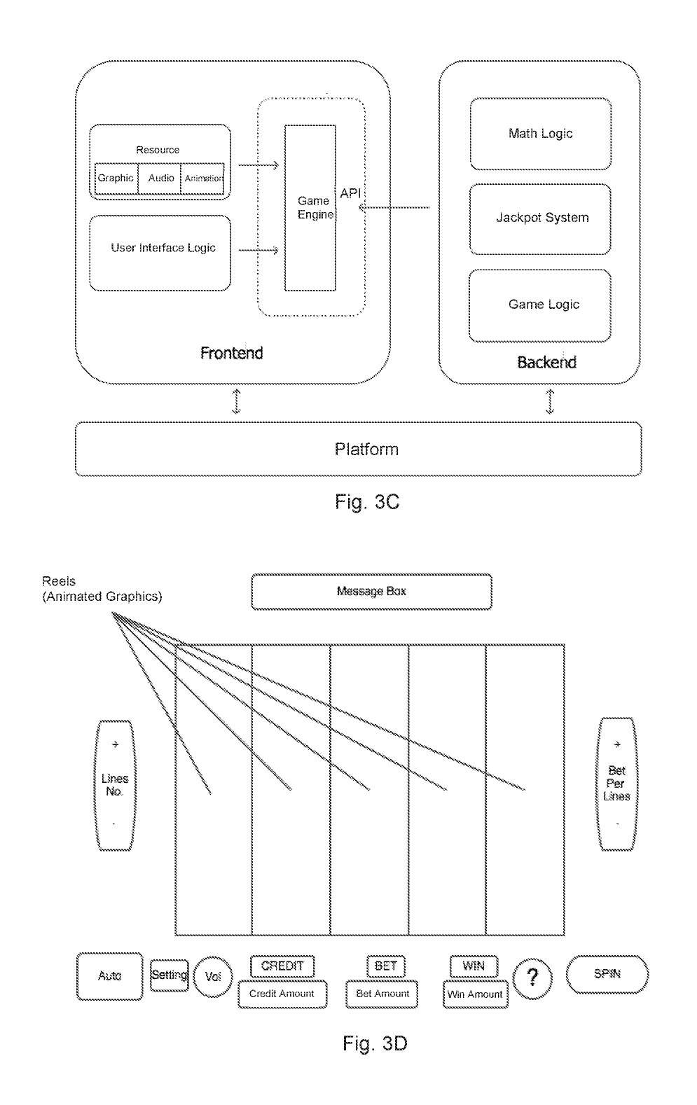

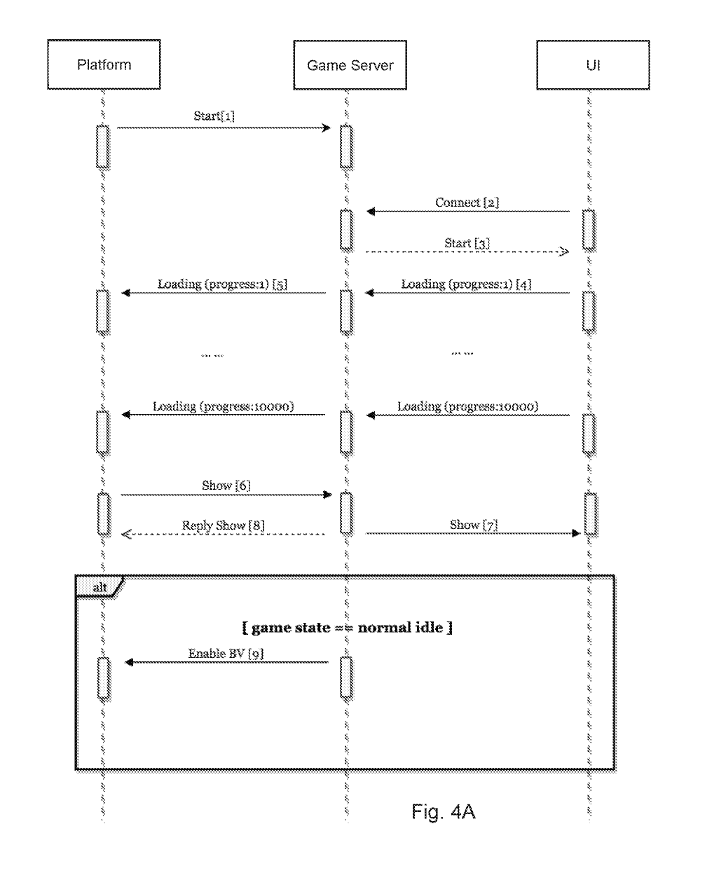

The Game Server in this example is a process server module and comprises a plurality of communication interfaces as depicted in FIG. 2B. The example Game Server comprises an example plurality of eight communication interfaces, and the communication interfaces are identified by the numerals GS1 to GS8. The example communication interfaces are identified by the reference labels: “Start” (GS1), “Show” (GS2), “Pause” (GS3), “Resume” (GS4), “Stop” (GS5), “Buttons” (GS6), “Update” (GS7), “OSD” (GS8).

The UI module in this example is a contents module and comprises a plurality of communication interfaces as depicted in FIG. 2C. The UI module comprises an example plurality of seven communication interfaces, which are represented by numerals U1 to U7 and identified by reference labels “Connect” (U1), “Login” (U2), “Help” (U3), “Meters” (U4), “Spin” (U5), “Save” (U6), “Finish” (U7). The example communication interfaces are in the form of application program interfaces (API).

The Game Server and the UI module are connected using a first type of socket and to communicate using a first type of communication protocol. The example socket for use in interconnection of the game server module and the UI module is “Web Socket”. Web Socket is used herein as an example communication protocol because contents of the UI module are built in HTML5. Web Socket is an HTTP related protocol under the HTTP standard which is more efficient and preferred for communication in relation to HTML5.

The Game Server and the Platform are connected using a second type of socket and to communicate using a second type of communication protocol. The example socket for use in interconnection of the game server module and Platform is “Nanomsg”. Nanomsg is a socket library implemented in C and provides several common communication patterns. Since the game server and the Platform would be written in C, for example, C++, a C-based socket is preferred to enhance communication efficiency between the Game Server and the Platform.

The UI module comprises materials for facilitating machine-user interface. The materials for facilitating machine-user interface are typically delivered as human perceivable signals by the controller upon execution of gaming instructions. The human perceivable signals when received by a user will be interpreted as human perceivable information, and the human perceivable information is to be delivered in the form of human perceivable signals. A human perceivable signal is typically linked or associated with a specific logic event so that a specific human perceivable signal will be delivered for presentation to a user on occurrence of a specific logic event. During operations, the machine controller upon execution of stored instructions will operate to retrieve a human perceivable signal for presentation on reaching a pre-determined specific logic event or state. Human perceivable signals used in machines typically comprise audible signals, visible signals and/or skin feelable signals. The audible signals may be in the form of voice, music, jingles, other audio signals, or their combination. The visible signals may be in the form of a graphical display, for example, animated graphics, texts, numbers, or their combination. The skin feelable signals may comprise motion signals, vibration signals or their combination.

The human perceivable information is stored as a plurality of indexed data files and each indexed data file may contain data of human perceivable signals or a link to a data source of human perceivable signals. The indexed files collectively define a data library which is a documentation library, and the documentation library forms a part of a module which is referred to as a library module or a content module. The library module is also referred to as a user interface module (“UI module”) since the data files stored in the library primarily relate to human perceivable signals to facilitate machine-to-user interface when outputted to a user interface device by the machine. A user interface device herein may be the VDU, the speaker, or other output peripheries without loss of generality. The human perceivable signals when presented on the VDU as an example of an output periphery may appear as stationary scenes, animated graphics, templates for displaying progress data, or a combination thereof. The animated graphics may be displayed as moving figures, moving articles and visual effects, such as visual effects of fire, explosion, net spreading, missile impact on a target etc., without loss of generality.

An example UI module comprises control logic in addition to the stored data files, as depicted in FIG. 2C. The control logics are stored as control instructions to facilitate control communications with the machine controller and the retrieval of data files from the library module by the controller and are stored in a control portion of the UI module. The control logics are accessible using the communication ports of the UI module using example API commands “Connect” (U1), “Login” (U2), “Help” (U3), “Meters” (U4), “Spin” (U5), “Save” (U6), “Finish” (U7).

### UI Module

The example communication ports of the UI module have the dedicated functions below.

“Connect” U1 is to connect the resources of the UI module to the Platform. An example message format of this API is: {“action”:“Connect”, “data”: {“helpPage”: 5}}, where the keyword “action” is to inform that the “action” to perform is to “Connect” and the material to connect is ‘helpPage’ which is a type of documentation, and the numeral parameter “5” is to indicate that there is a maximum page number of 5. The Game Server will not provide a return message or a return response when this message is received.

“Login” U2 is to provide information on loading progress in percentage terms. An example message format of this API is: {“action”:“Login”, “data”: {“progress”: 10000}}, wherein the numeric data “10000” can be a value between 100 (0%) and 10000(100%). The Game Server will not provide a return message or a return response when this message is received.

“Help” U3 is for controlling the Help screen. An example message format of this API is: {“action”:“Help”,“data”:{“action”:“Open”}}, where four alternative action parameters: Open, Close, Previous and Next, are available for selection. Upon receipt of the “Help” message, the Game Server is to return a message, and an example return message is excerpted below:

| | |
|---|---|
| { | “ |
| “action”:“Help”, | }, |
| “gameState”:1, | “meters”:{ |
| “flags”:{ | “betMultiple”:20, |
| “decreaseBetMultiple”:true, | “credit”:977780, |
| “decreaseLine”:true, | “line”:0, |
| “help”:true, | “totalBet”:1400, |
| “increaseBetMultiple”:false, | “totalWin”:5260 |
| “increaseLine”:false, | }, |
| “setting”:true, | “normal”:{ |
| }, | } |
| help”:{ | } |
| “currentPage”:1, | |
| “maxPage”:4, | |
| “state”:“open” | |

“Meters” U4 is for changing the total bet. An example message format of this API is: {“action”:“Meters”,“data”:{“key”:“BetMultiple”,“value”:−1}}. Two key parameters are available, namely BetMultiple and Line number. A value of 1 means to increase while a value of −1 means to decrease. Upon receipt of the “Help” message, the Game Server is to return a message, and an example return message is excerpted below:

| | |
|---|---|
| { | “meters”:{ |
| “action”:“Meters”, | “betMultiple”:20, |
| “gameState”:1, | “credit”:977780, |
| “flags”:{ | “line”:0, |
| “decreaseBetMultiple”:true, | “totalBet”:1400, |
| “decreaseLine”:true, | “totalWin”:5260 |
| “help”:true, | }, |
| “increaseBetMultiple”:false, | “normal”:{ |
| “increaseLine”:false, | } |
| “setting”:true, | } |
| }, | |

“Spin” U5 is a game cycle start message, to indicate the beginning of a game cycle. An example request format is: {“action”:“Spin”}. Upon receipt of the “Help” message, the Game Server is to return a message, and an example return message is excerpted below:

| | |
|---|---|
| { | { |
| “action”: “Spin”, | “win”: 360, |
| “gameState”: 2, | “pos”: [11, 12, 13], |
| “versionType”: 2, | “winType”: “four” |
| “platformConfig”: { | }, |
| “rtp”: 0.9434, | { |
| “autoPlay”: false, | “pos”: [0, 1, 2], |
| “currency”: “EUR”, | “winType”: “straight”, |
| “language”: “English”, | “win”: 40 |
| “centPerYuan”: 100, | }, { |
| “deno”: 1, | “pos”: [3, 4, 5], |
| “autoGamble”: false, | “winType”: “straight”, |
| “soundVolume”: 0 | “win”: 40 |
| }, | }, { |
| “meters”: { | “pos”: [4, 5, 6], |
| “totalBet”: 1, | “winType”: “straight”, |
| “betMultiple”: 1, | “win”: 40 |
| “totalWin”: 120, | } |
| “credit”: 999999989, | ] |
| “line”: 0 | }, |
| }, | “symbols”: { |
| “flags”: { | “extra”: { |
| “help”: false, | “gandCards”: [31], |
| “setting”: false, | “faCards”: [61, 62, 63] |
| “decreaseBetMultiple”: false, | }, |
| “decreaseline”: false, | “data”: [11, 12, 13, 16, 17, |
| “increaseline”: false, | 18, 19, 21, 24, 28, 28, 33, 39, 39] |
| “increaseBetMultiple”: true | }, |
| }, | “fungPosition”: 41 |
| “normal”: { | }, |
| “normalType”: “base”, | “help”: { |
| “wins”: { | “currentPage”: 1, |
| “extra”: [ ], | “state”: “close”, |
| “data”: [{ | “maxPage”: 5 |
| “win”: 36, | } |
| “pos”: [ ], | } |
| “winType”: “fa” | |
| }, | |

“Save” or “SaveNv” U6 is used to preserve certain game data, for example, data of the type OSD or Feature, preferably data having a size of smaller than 1 k. The “Save” API has the below example format:

| | |
|---|---|
| SaveNV | {“action”:“SaveNv”, “data”: {“nvName”: ‘osd/feature’, |
| | “nvData”: {...}}} |

Upon receipt of this request message, the Game Server is to return the same message as a feedback or return message.

“Finish” U7 is used for action after receiving a response from the Game Server to the UI module. The action is to base on the gameState and has the below example message format:

| | |
|---|---|
| Finish | {“action”:“Finish”} |

Upon receipt of this request message, the Game Server is to return a gameState dependent message.

### Game Server

“Start” GS1 event. This is an event initiated by the Platform and for the Game Server to notify the UI to begin loading resources after the Game Server is in receipt of the notification that the Platform has initialized the game. Below is an example format of this event.

| | |
|---|---|
| Start | { “action”:“Start”, “progressEnd”:10000, “progressStart”:0} |

“Show” GS2 event. This event is initiated by the Platform and for the Game Server to inform the UI to show a game window. Below is an example format of this event.

| | | |
|---|---|---|
| Show | { | “flags”: |
| | “action”: “Show”, | { |
| | “versionType”: 2, | “help”: true, |
| | “gameState”: 1, | “setting”: true, |
| | “platformConfig”: { | “decreaseBetMultiple”: false, |
| | “rtp”: 0.9434, | “decreaseline”: false, |
| | “autoPlay”: false, | “increaseline”: false, |
| | “currency”: “EUR”, | “increaseBetMultiple”: true |
| | “language”: “English”, | }, |
| | “centPerYuan”: 100, | “normal”: { |
| | “deno”: 1, | “symbols”: { |
| | “autoGamble”: false, | “extra”: [ ], |
| | “soundVolume”: 0 | “data”: [ ] |
| | }, | }, |
| | “meters”: { | “wins”: { |
| | “totalBet”: 1, | “extra”: [ ], |
| | “betMultiple”: 1, | “data”: [ ] |
| | “totalWin”: 0, | } |
| | “line”: 0, | }, |
| | “credit”: 999999990 | “help”: { |
| | }, | “currentPage”: 1, |
| | “feature”: { | “state”: “close”, |
| | “triggeredList”: [ ], | “maxPage”: 5 |
| | “uiData”: [ ] | } |
| | }, | } |

“Pause” GS3 event. This event is initiated by the Platform and for the Game Server to inform the UI to pause a game. Below is an example format of this event.

| | |
|---|---|
| Pause | { “action”:“Pause” } |

“Resume” GS 4. This event is initiated by the Platform and for the Game Server to inform the UI to resume a game after a pause.

| | | |
|---|---|---|
| Resume | { | }, |
| | “action”: “Resume”, | “meters”: { |
| | “versionType”: 2, | “totalBet”: 1, |
| | “gameState”: 1, | “betMultiple”: 1, |
| | “platformConfig”: { | “totalWin”: 0, |
| | “rtp”: 0.9434, | “line”: 0, |
| | “autoPlay”: false, | “credit”: 999999990 |
| | “currency”: “EUR”, | }, |
| | “language”: “English”, | “feature”: { |
| | “centPerYuan”: 100, | “triggeredList”: [ ], |
| | “deno”: 1, | “uiData”: [ ] |
| | “autoGamble”: false, | }, |
| | “soundVolume”: 0 | |

“Stop” GS5. This event is initiated by the Platform and for the Game Server to inform the UI to stop a game. Below is an example event format of this event.

| | |
|---|---|
| Stop | { “action”:“Stop” } |

“Buttons” GS6. This event is for the Game Server to respond to button operations. A button herein is an example of user control interface and example action parameters are press and release. Below is an example format of this event.

| | |
|---|---|
| Buttons | { |
| | “action”: “Buttons”, |
| | “data”: { |
| | “key”: “SPIN”, |
| | “state”: “press” |
| | } |
| | } |

“Update” GS7. This event is for the Game Server to notify the UI to update, without affecting gameState. Below is an example event format of this event.

| | | |
|---|---|---|
| Update | { | “betMultiple”: 1, |
| | “action”:“Update”, | “totalWin”: 0, |
| | “gameState”:5, | “line”: 0, |
| | “feature”:{ | “credit”: 999999990 |
| | ... ... | }, |
| | }, | “normal”:{ |
| | “flags”:{ | “symbols”: { |
| | “help”: true, | “extra”: [ ], |
| | “setting”: true, | “data”: [ ] |
| | “decreaseBetMultiple”: false, | }, |
| | “decreaseline”: false, | “wins”: { |
| | “increaseline”: false, | “extra”: [ ], |
| | “increaseBetMultiple”: true | “data”: [ ] |
| | }, | } |
| | “meters”:{ | } |
| | “totalBet”: 1, | } |

“OSD” GS8. This event is for the Game Server to notify the UI of certain operation details of the Platform, and the UI is to display a message corresponding to an event name. Below is an example event format of this event.

| | |
|---|---|
| OSD | { |
| | “action”: “OSD”, |
| | “data”: { |
| | “event”: “Event Name”, |
| | “time”: “”, // time of occurrence of event, system time stamp |
| | “type”: 1, a non-zero type means occurrence of an error (e.g., |
| | BV_DISCONNECTED). If zero, error has been removed. |
| | “value”: “”, // use to show credit value in a message (relating |
| | to specific event) |
| | } |
| | } |

Example OSD events (“Event List”) are set up below

| | |
|---|---|
| BV_REJECTED | BELLY_DOOR_CLOSED |
| BV_JAM | RAM_RESET |
| BV_DISCONNECTED | CASH_IN |
| PRINTER_PAPER_LOW | TICKET_IN |
| PRINTER_PAPER_JAM | TICKET_OUT |
| PRINTER_DISCONNECTED | HAND_PAY |
| PROCESSOR_DOOR_CLOSED | UPPER_DOOR_CLOSED |
| NOTE_DOOR_CLOSED | MAIN_DOOR_CLOSED |
| METER_DOOR_CLOSED | LOGIC_BOX_DOOR_CLOSED |
| CASHBOX_DOOR_CLOSED | |

Example game states (gameState) are shown below.

| ID | Name | Finish |
|---|---|---|
| 1 | NORMAL IDLE | NO |
| 2 | NORMAL CYCLE | YES |
| 3 | NORMAL TO FEATURE | YES |
| 4 | FEATURE IDLE | NO |
| 5 | FEATURE CYCLE | YES |
| 6 | FEATURE TO NORMAL IDLE | YES |
| 7 | HAND PAY | NO |
| 8 | TICKET OUT | NO |
| 9 | TICKET OUT FAILED | NO |

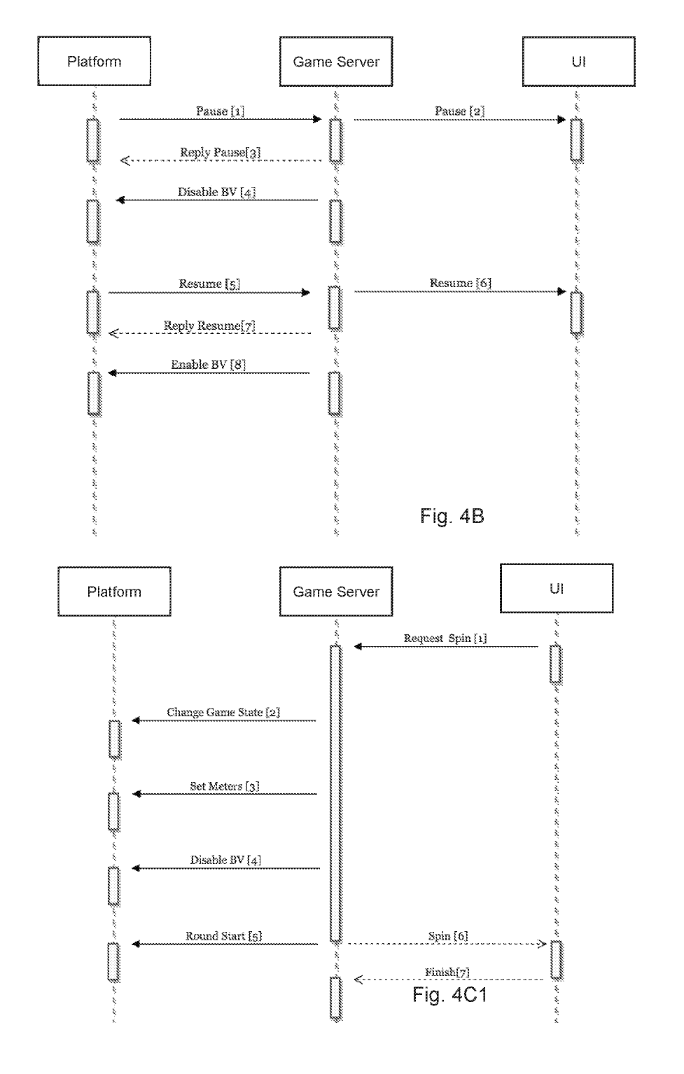

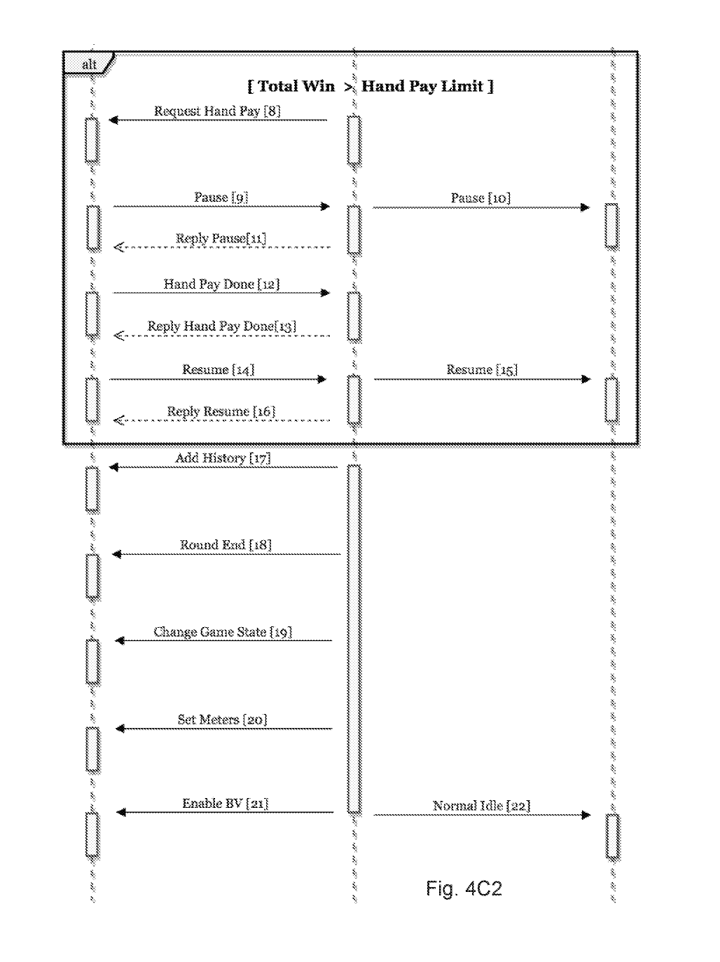

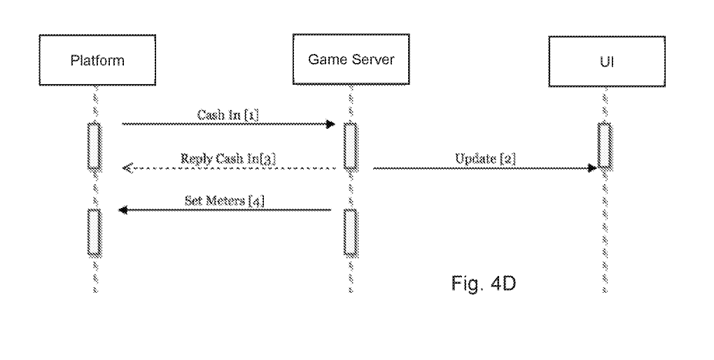

An example gaming apparatus of FIG. 3A comprises the Platform, a plurality of platform modules, and a game. The plurality of modules comprises a Game Server Module, a UI module, a bill validator (“BV”) module, a ticket printer module, a control module and an SAS module. The game comprises the Game Server and the UI module. The Platform is built on Linux Debian 9.3 64 bit operation system (“OS”).

The Platform includes a Hardware module which is configured to support hardware devices such as logic box driver, door switch including tower light (sensor), touchscreen calibration, NVRAM management, printer normal printing, printer ticket printing, BV read bill note, BV read ticket, etc.

The Audit Menu module is to support dedicated functions such as Hand Pay Display, Hand Pay Record Display, Master Meter Display, Progressive Meter Display, Game Meter Display, Security Meter Display, Bill Meter Display, Cash-In Record Display, Ticket-In Record Display, Ticket-Out Record Display, Cashless-In Record Display, Cashless-Out Display, Event Record Display, Game History Recall, Hardware & Software Information Display, etc.

The Audit Configuration is to support configurations such as: Game Client Configuration Game Configuration, Protocol Configuration, Bet Configuration.

The SAS module is to support SAS structure framework, SAS meters transmission, SAS General poll and Long Poll, SAS TITO, etc.

To prepare for execution of the game, the Platform is to load the game components into the data storage device. To commence running of a game, the Platform is to execute platform instructions to load the game components into its volatile memories and then to execute gaming instructions to run the game. Upon receipt of instructions to commence running of the game, the Platform is to connect with the Game Server and the UI module.

### Loading

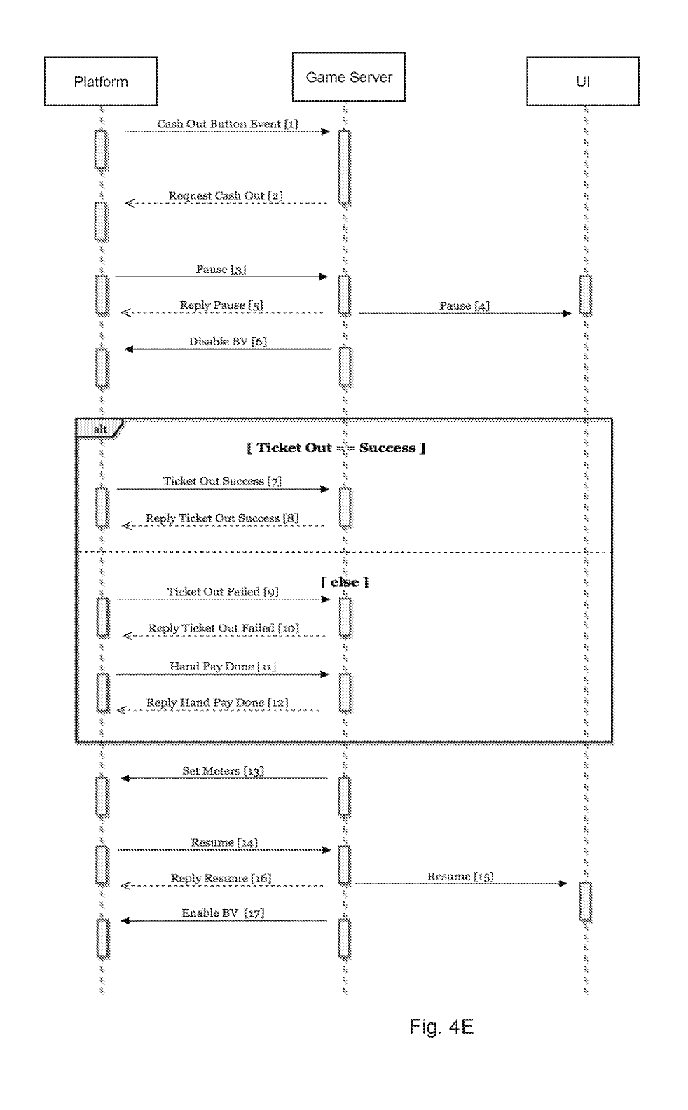

Referring to FIG. 4A, the Platform to initialize the game process is to send a ‘Start’ [1] message to the Gamer Server. After the Game Server and the Platform have established data connection, the Game Server is to establish data connection with the UI module and to notify the UI module of game initialization. After the UI module has connected with the Game Sever, the UI module is to send a ‘Connect’ [2] message to the Game Server as a first response after initialization. After the Game Server has received a ‘Connect’ message from the UI module, the Gamer Server is to return or respond with a ‘Start’ [3] message to notify the UI module to commence loading operations. In response to the Start message, the controller will operate to transfer materials contained in the UI module to the controller, or more specifically, to the volatile memories of the controller. During the material transfer process, the UI module will send a progress status message ‘Loading’ (progress: 1) [4] to the Game Server and the Game Server will send a progress status message ‘Loading’ (progress: 1) [5] to the Platform. When the material transfer is complete, the UI module will send a progress status message ‘Loading’ (progress: 10000) [4] to the Game Server and the Game Server will send a progress status message ‘Loading’ (progress: 1000) [5] to the Platform. After UI material loading has complete, the Platform is to send a “Show” [6] message to the Game Server. Upon receipt of the “Show” [6] message, the Gamer Server is to send a “Show” [7] message to the UI module. Upon receipt of the “Show” [7] message, the UI module is to initialize to display a user interface and await user instructions. Before receipt of this “Show” [7] message, the UI interface will be minimized. In addition, the Gamer server is to send a “Reply Show” [8] message to the Platform. After the “Reply Show” [8] message has been sent by the Gamer Server to the Platform, the game loading process is complete and the machine is ready to operate as a gaming machine for running the specific game just loaded.

In some embodiments, the controller is to start a game process immediately after game loading has completed. In alternative embodiments, the controller upon successful loading and connection of the UI module will set the gameState into “Normal Idle” to indicate that the machine is in an idling state and is ready for game running, and await receipt of game commencement instructions from a user. The game commencement instruction is a user command which is typically sent from a user control interface.

Upon receipt of instructions to commence a game, the Game Sever is to send an “Enable BV” [9] message to the Platform. The “Enable BV” enables bill validation so that credits and debits of the user are tracked.

In this example, the Start [1] message has a data format of: {“eventType”: 101, “data”: {“code”: 1, “data”: [ . . . ]}}]; and the Connect [2] message has a data format of {“action”:“Connect”, “data”: {“helpPage”: 5}}, wherein “helpPage” means nature of the material and the number 5 means a maximum of 5 pages. The Start message has a data format of: {“action”:“Start”,“progressEnd”:10000,“progressStart”:0}, where the parameter,“progressStart”:0 means commencement of process and “progressEnd”:10000 means completion of the loading process when progress status reaches 100000(100%). When the loading status has reached progressEnd, the Gamer Server will treat the UI material loading as complete and send a message having a data format: {“action”:“Login”, “data”: {“progress”: 10000}}. During the loading progress, the loading progress is to provide an update of the progress status with a message having a data format: {“eventType”: 0, “data”: {“code”: 1, “data”: [progress, . . . ]}}. The “Show” message [6] has an example data format of {“eventType”: 101, “data”: {“code”: 5, “data”: [ . . . ]}}. The “Show” message [7] has an example data format of {“action”:“Show”,“gameState”:5,“flags”:{ . . . },“meters”:{ . . . },“normal”:{ }}. The “Show” message [8] has an example data format of {“eventType”: 101, “data”: {“code”: 5, “data”: [ . . . ]}}. The “Enable BV” [9] message has an example data format of: {“eventType”: 1, “data”: {“code”: 5, “data”: [1, . . . ]}}.

When the Platform intends to pause the game, the Platform will transmit a “Pause” message and the game will enter a ‘paused’ state after receipt of the “Pause” instruction and until the Platform sends out a ‘Resume’ message to resume.

### Pause and Resume

Referring to FIG. 4B, the Platform is to transmit a “Pause” [1] message to the Game Server when the Platform requires the game to pause. Upon receipt of the “Pause” [1] message, the Gamer Server is to transmit a “Pause” [2] message to the UI module to inform the UI module to enter a ‘paused’ state. To acknowledge receipt of the “Pause” [1] instruction, the Game server is to respond by sending a “Reply Pause” [3] message to the Platform. In addition, the Gamer Server is to send a “Disable BV” [4] message to the Platform. When the Platform intends to resume game running, the Platform is to transmit a “Resume” [5] message to the Game Server. The Game Server upon receipt of the “Resume” [5] message from the Platform is to send a “Resume” [6] message to the UI module. After the Game Server has executed the “Resume” [5] instructions, the Game Server is to acknowledge receipt of the “Resume” [5] instructions by sending a “Reply Resume” [7] message to the Platform. After that, the Game Server is to send an “Enable BV” message [8] to the Platform and the game process will resume.

The example data formats for the above message are set out below:

| | | |
|---|---|---|
| [1] | Pause | {“eventType”: 101, “data”: {“code”: 3, “data”: [ ...]}}. |
| [2] | Pause | {“action”:“Pause”}. |
| [3] | Pause | {“action”:“Pause”}. |
| [4] | Disable | {“eventType”: 1, “data”: {“code”: 6, “data”: [1, ...]}}. |
| | BV | |
| [5] | Resume | {“eventType”: 101, “data”: {“code”: 4, “data”: [ ...]}}. |
| [6] | Resume | {“action”:“Pause” , ...}. |
| [7] | Reply | {“eventType”: 101, “data”: {“code”: 4, “data”: [ ...]}}. |
| | Resume | |
| [8] | Enable | {“eventType”: 1, “data”: {“code”: 5, “data”: [1, ...]}}. |
| | BV | |

### Game Cycle

An example game cycle is illustrated with reference to FIGS. 4C1 and 4C2. When user-initiated instructions to commence the game are received by the UI module, the UI module is to send a “Request Spin” [1] message to the Game Server. The Game Server is to send a “Change Game State” [2] to the Platform upon receipt of the “Request Spin” [1] message. In addition, the Gamer Server is to send the messages “Set Meters” [3], “Disable BV” [4], “Round Start” [5] to the Platform. The “Set Meters” message is to report user data, for example, Total Credit B, to the Platform before commencement of a game cycle. At the beginning of a game cycle, it is necessary to disable BV. When the Game Server is ready to commence a game cycle, the Gamer Server is to notify the Platform by sending a “Round Start” [5] message and to notify the UI module by the message “Spin” [6]. After a “Spin” [6] instruction has been performed, the UI module is to return a “Finish” [7] message to the Gamer Server.

Referring to FIG. 4C2, an example situation requiring human assistance has occurred during a game cycle. The example situation is a hand pay situation which is a situation where the machine requires human intervention or human assistance. Such a situation may arise, for example, when the reward to be paid exceeds a limit and requires human intervention. Upon occurrence of a hand-pay situation, the Game server is to send a “Request Hand Pay” [8] message to the Platform. The Platform upon receipt of the situation is to reply will a “Pause” [9] message. The Gamer Server upon receipt of the “Pause” [9] instruction is to send a “Pause” [10] message to the UI module. After the Game Module has sent the “Pause” [10] instruction to the UI module, the Game Server is to acknowledge receipt of the “Pause” [9] instruction by sending a responsive message of “Reply Pause” [11]. After the situation has been resolved with human assistance or human intervention, the Platform is to send a “Hand Pay Done” [12] message to the Game Server. The Game Server in response is to send a “Reply Hand Pay Done” [13] message to the Platform to feedback or acknowledge receipt of the “Hand Pay Done” [12] instructions. Upon receipt of the Reply Hand Pay Done” [13] message, the Platform is to send a “Resume” [14] message to the Gamer Server. The Game Server upon receipt of the “Resume” [14] instruction is to send a “Resume” [15] message to the UI module. After the “Resume” [15] message has been sent, the Game Server is to further send a “Reply Resume” [16] message to the Platform to feedback or acknowledge receipt of the “Resume” [14] instructions.

After a game cycle has ended, historic events of the game need to be recorded. For this purpose, the Game Server is to send an “Add History” [17] message to the Platform. In addition, the Game Server is also to send “Round End” [18], “Change Game State” [19], “Set Meters” [20] and “Enable BV” [21] messages to the Platform. In addition, the Gamer Server is also to send a “Normal Idle” [22] message to the UI module. The “Round End” message is to inform the Platform that the game cycle has ended. The “Change Game State” message is to notify the Platform that a game cycle has ends and to return to the idle state. The “Set Meters” message is to report the updated meter values to the Platform, and parameters include, for example, “credit total win” etc. The “Enable BV” message is to re-enable bill validator and the “Normal Idle” message is to notify the UI module to return to the normal idle state and await the next game commencement instructions.

The example data formats for the above message are set out below:

| | | |
|---|---|---|
| [1] | Request Spin | {“action”:“Login”, “data”: [...]} |
| [4] | Disable BV | {“eventType”: 1, “data”: {“code”: 6, “data”: [1, ...]} |
| [6] | Spin | {“action”:“Spin”,“gameState”:3,“flags”:{...},“meters”:{...},“normal”:{ }} |
| [7] | Finish | {“action”:“Finish”} |
| [8] | Request Hand | {“eventType”: 201, “data”: {“code”: 11, “data”: [...]}} |
| | Pay | |
| [9] | Pause | {“eventType”: 101, “data”: {“code”: 3, “data”: [ ...]}} |
| [10] | Pause | {“action”:“Pause”} |
| [11] | Reply Pause | “action”:“Pause”} |
| [12] | Hand Pay Done | “action”:“Pause”} |
| [13] | Reply Hand | {“eventType”: 201, “data”: {“code”: 12, “data”: [ ...]}} |
| | Pay Done | |
| [14] | Resume | {“eventType”: 101, “data”: {“code”: 4, “data”: [ ...]}} |
| [15] | Resume | {“action”:“Pause” , ...} |
| [16] | Reply Resume | {“eventType” 101, “data”: {“code”: 4, “data”: [ ...]}} |
| [18] | Round End | {“eventType”: 1, “data”: {“code”: 4, “data”: [1, ...]}} |
| [21] | Enable BV | {“eventType”: 1, “data”: {“code”: 5, “data”: [1, ...]}} |
| [22] | Normal Idle | {“action”:“Finish”,“gameState”:1,“flags”:{...},“meters”:{...},“normal”:{ }} |

The messages not included in the above table are to communicate directly using the communication ports.

### Cash-in

An example game event, known is Cash-In, is depicted in FIGS. 4C1 and 4C2. When a user has injected funds or credits to its account, for example, through the BV (bill validator) or ticket machine (Ticket), this event is known as Cash-In, and the Platform and the Game Serve will exchange messages to facilitate Cash-In.

After the bill validator has received credits in the form of cash or ticket, the Platform will transmit a ‘Cash-In’ [1] event message to the Game Server to notify the Game Server that a user account has received credit. Upon receipt of the ‘Cash-In’ [1] message, the Game Server will convert the received fund into credit units, to increase the credit value in the user account, and then to send an “Update” [2] message to notify the UI module. The UI module on receipt of the “Update” [2] message will update the human perceivable signals representing the credit state of the user account for display on the VDU. In addition, the Game Server will also inform the Platform of the new meter value Platform by sending a “Meter” message.

Example message formats of the Cash-In event are set out below:

| | | |
|---|---|---|
| [1] | Cash-In | {“eventType”: 6, “data”: {“code”: 3, “data”: [...]}} |
| [2] | Update | {“action”:“Update”,“gameState”:1,“flags”:{...},“meters”:{...},“normal”:{ }} |
| [3] | Reply Cash-In | {“eventType”: 6, “data”: {“code”: 3, “data”: [...]}} |
| [4] | Set Meters | Direct data communication |

### Cash-Out

An example game event, known is Cash-Out, is depicted in FIG. 4D. A Cash-Out event is a payout event that requires external assistance. External assistance herein means assistance provided from outside the machine, and may include, for example, assistance by human attendance. In example situations such as when Ticket Out function fails, a situation known as “Hand Pay” will arise. When “Hand Pay” situation occurs, an attendant will intervene and provide pay-out to a machine user.

To trigger “Cash-Out”, a user may activate a cash-out button on the machine to indicate a “Cash-Out” event. The Platform upon receipt of a “Cash-Out” request will send a “Cash-Out Button Event” [1] message to the Game Server. Upon receipt of the “Cash-Out Button Event” [1] message, the Game Server will respond by sending a “Reply Cash Out” reply message to the Platform to acknowledge receipt of the “Cash-Out Button Event” [1] message. The Platform upon receipt of the “Reply Cash Out” reply message is to send a “Pause” [3] message to the Game Server. The Game Server upon receipt of the “Pause” [3] message is to send a “Pause” [4] message to the UI module and a “Reply Pause” [5] message to the Platform. The UI module upon receipt of the “Pause” [4] message is to freeze the UI module output to correspond to a game pause state. Furthermore, the Game Server is to send a “Disable BV” [6] message to interrupt bill validation.

In some situations, Ticket Out is successful, the Platform will send a “Ticket Out Success” [7] message to the Game Server after ticket out is done. The Game Server upon receipt of the “Ticket Out Success” [7] message is to send a reply message “Reply Ticket Out Success” [8] to the Platform to acknowledge receipt of the “Ticket Out Success” [7] message.

In other situations, “Ticket Out” failed. When “Ticket Out” failed, the Platform is to enter into a “Hand Pay” event and send a “Ticket Out Failed” [9] message to the Game Server after hand-pay has completed. The Game Server upon receipt of the “Ticket Out Failed” [9] message is to send a reply message “Reply Ticket Out Failed” [10] to the Platform to acknowledge receipt of the “Ticket Out Failed” [8] message. When hand-pay is done, the Platform is to send a “Hand Pay Done” [11] message to the Game Server and the Gamer Server in response is to send a reply message “Reply Hand Pay Done” [12] to the Platform to feedback and acknowledge receipt of the “Hand Pay Done” [11] message.

After payment made-out is done, the Game Server is to send a “Set Meters” [13] message to the Platform to refresh the credit status of the user account. The Platform upon receipt of the “Set Meters” [13] message is to send a “Resume” [14] message to notify the Game Server to resume game running and to continue running from where the game is paused ay steps [3] and [4]. The Game Server upon receipt of the “Resume” [14] message is to send a “Resume” [15] message to the UI module so that the UI module is to output human perceivable signals commensurate with the resume game status for user interaction. In addition, the Game Server is also to send a “Reply Resume” [16] message to the Platform to feedback and acknowledge receipt of the “Resume” [14] message. Furthermore, the Game Server is to send an “Enable BV” [17] message to the Platform to activate the bill validator.

Example message formats of the Cash-In event are set out below:

| | | |
|---|---|---|
| [1] | Cash Out | {“eventType”: 21, “data”: {“code”: 1, “data”: |
| | Button Event | [4, ...]}} |
| [2] | Request | {“eventType”: 201, “data”: {“code”: 1, “data”: |
| | Cash Out | [ ...]}} |
| [3] | Pause | {“eventType”: 101, “data”: {“code”: 3, “data”: |
| | | [ ...]}} |
| [4] | Pause | {“action”:“Pause”} |
| [5] | Reply Pause | {“action”:“Pause”} |
| [6] | Disable BV | {“eventType”: 1, “data”: {“code”: 6, “data”: |
| | | [1, ...]}} |
| [7] | Ticket Out | {“eventType”: 201, “data”: {“code”: 2, “data”: |
| | Success | [ ...]}} |
| [8] | Reply Ticket | {“eventType”: 201, “data”: {“code”: 2, “data”: |
| | Out Success | [ ...]}} |
| [9] | Ticket Out | {“eventType”: 201, “data”: {“code”: 2, “data”: |
| | Failed | [ ...]}} |
| [10] | Reply Ticket | {“eventType”: 201, “data”: {“code”: 2, “data”: |
| | Out Failed | [ ...]}} |
| [11] | Hand Pay Done | {“eventType”: 201, “data”: {“code”: 12, “data”: |
| | | [ ...]}} |
| [12] | Reply Hand | {“eventType”: 201, “data”: {“code”: 12, “data”: |
| | Pay Done | [ ...]}} |
| [13] | Set Meters | Direct communication |
| [14] | Resume | {“eventType”: 101, “data”: {“code”: 4, “data”: |
| | | [ ...]}} |
| [15] | Resume | {“action”:“Pause” , ...} |
| [16] | Reply Resume | {“eventType”: 101, “data”: {“code”: 4, “data”: |
| | | [ ...]}} |
| [17] | Enable BV | {“eventType”: 1, “data”: {“code”: 5, “data”: |
| | | [1, ...]}} |

An example gaming machine comprises a main housing, display means, user interface means, and operational mechanisms. The operational mechanisms include both a set of software mechanisms (or soft operational mechanisms) and a set of hardware mechanisms which are to cooperate to perform the many functions of a gaming machine. The software mechanisms of a gaming machine include software and the software which can be classified according to their specific functions or specific functional aspects. For example, a gaming machine software can be classified as a resource type software, a user interface type software, a mathematical logic type software (also known as a gaming logic type software), and a jackpot type software. The resource type software, the user interface type software, the mathematical logic type software (also known as a gaming logic type software), and the jackpot type software are commonly accepted as the essential types of software components that are essential to the operation of modern and sophisticated gaming machines.

The various essential types of software components would need to cooperate in order to perform the functions of the software mechanisms and further need to cooperate with the hardware mechanisms in order to perform the functions for a gaming machine according to specifications approved by authorities.

As the performance of a gaming machines concerns substantial public interests, each essential software component would need to meet stringent acceptability and compliance requirements, and the costs to meet the stringent acceptability and compliance requirements are not insubstantial, especially for small or smaller players in the gaming machine industries.

An electronic platform proposed to alleviate the aforesaid problems has been devised. The electronic platform is a machine-based platform which is to operate by a computer to facilitate multi-party working and multi-party cooperation to generate or produce software mechanisms of a gaming machine. The platform provides an integration platform where multiple related parties can work together and build software mechanisms of choice or preference, as depicted in FIGS. 1 and 1A.

For example, the integration platform provides an electronic platform for software developers to vend in various types of gaming machine software; a gaming machine vendor, whether a major player, a novice or a small or medium player, can build the software mechanisms for operating a gaming machine by selecting some or all the software components available on the platform; and at the same time, a gaming machine vendor can make available hardware mechanisms on the platform for selection by other gaming machine vendors. The selected software components will be combined or assembled to form a set of operational software mechanisms to operate a gaming machine and the assembled software mechanisms are to be incorporated in the hardware mechanisms to form an operational gaming machine, as depicted in FIGS. 3A and 3B.

The soft operational mechanisms of a gaming machine may be classified into four basic categories, namely, resource, user interface, logic (including math logic and game logic) and jackpot.

An example gaming machine according to the disclosure comprises a hardware portion and a software portion, as schematically depicted in FIGS. 3A and 3B. The hardware portion comprises example devices as a touch screen display, speakers, buttons, sticks and switches, and bill validator. The software portion comprises a game client portion and a game logic server portion. The game client portion comprises an audio portion, a graphic portion, a text portion, a user interface portion and an executable file portion. The game logic server portion comprises a main logic portion, a jackpot portion, a hardware communication library, a set of local databases and a random number generator. The hardware portion and the software portion are linked up to form a gaming machine.

The term “resource” herein means all media resources or resource materials that would be used in a game, including graphic, sound or animation etc. In typical gaming applications, the resource materials are centered and built around a theme. For applications of a slot machine, the resource materials would relate to a main idea e.g. a movie topic, or an art theme such as animals, vehicles or an era.

The term “user interface” (UI) herein refers to means to facilitate user interaction. Typical user interface means include buttons, sticks, pedals, display screens, etc. A good UI is always pivotal to enhanced user performance and hence user satisfaction. For applications of a slot machine, UI may include one or more of logic, button, layout and appearance of a display screen, and the design typically depends on input method of device, such as touchscreen, mouse, keyboard or physical button.

Where a gaming machine is reward based, especially when the reward is pecuniary-based or pecuniary-linked, the gaming machine always has mathematical mechanisms to facilitate determination of events leading to a reward and reward rates. In general, reward rates are related to RTP (return-to-player), volatility, hit-rate, trigger rate, maximum reward. In the example of slot machines, the rewards are also linked to the reel number and pay-lines. In addition, a gaming machine also includes a gaming logic mechanism which determines game flows. The mathematical mechanisms and the gaming logic mechanism are collectively referred to as a logic mechanism for convenience.

While the usual rewards of a reward-based gaming machine are largely determined by the mathematical mechanisms, a reward-based gaming machine, for example a slot machine, typically includes a “jackpot” system to award a jackpot having a value that is substantially or enormously higher than the usual awards, which are typically calculated to achieve a par-RTP or a near-par RTP. The jackpot system is usually related to the performance and performance parameters of a group of linked gaming machines and is usually establishment specific. A reward-based gaming machine which is deployed in a linked machine environment, such as casinos, typically has a jackpot system to link up with other gaming machines to attract users.

For example, the integration platform may provide an electronic platform for resource developers to vend in various types of resources such as gaming machine contents. The resource or gaming machine contents may include presentation graphics, images, photos, gaming flows, banners, slogans, jingles, audio effects, video effects, or other game graphics without loss of generality.

For example, the integration platform may provide an electronic platform for content developers to vend in various types of combined gaming machine software and contents. For example, a vendor may submit a gaming software module having built-in graphics. Alternatively, gaming modules and gaming graphics may separately selectable for combination.

For example, a selected audio content will be played by a gaming machine on reaching a certain stage or on occurrence of a certain event, and a selected image or graphic will be displayed on the display screen of a gaming machine on reaching a certain stage or on occurrence of a certain event.

When the various resources components and software components have been assembled to form a complete set of operational mechanisms, the electronic platform will be compiled or will be converted to a set of executable files which is operable on a pre-determined hardware environment. For example, a set of assembled software mechanisms, comprising both resources components and software components may be adapted for applications under different operational environments, for example, in video bingo, jackpots, video poker, slot machine, pachinko, pachinko-slot, free play casual gaming, mobile and internet gaming, skill-based gaming, multi-station gaming terminal environments.

The set of operational mechanisms may for example be outputted according to the GLI-19 interactive gaming standards for internet gaming applications or social gaming applications. For example, the set of operational mechanisms may be outputted according to the GLI-11 interactive gaming standards for land-based operations such as casino, playhouse or club-house operations. For example, the set of operational mechanisms may be outputted by the platform according to both the GLI-11 and GLI-19 standards for both types of operations. The computer of the platform would operate to make machine compilation or machine conversion or machine adaptation for the various applications.

The selection of various components may be automated by machine matching, for example, by AI (artificial intelligence) matching; by semi-automation with human-machine interaction plus AI matching; or by manual matching without loss of generality. For example, an end user may provide definitive parameters and/or instructions and the platform, or the underlying computer, will operate to perform AI matching to mix and match components to assemble a set of operational components.

In order to make available a pool of components available for choice and assembly by combination, the platform is open to contribution by contributors. The contributors may be classified as resource vendors, software vendors, hardware vendors, or other types of vendors as appropriate.

Before a gaming machine software or a gaming machine hardware contributed by a software vendor is accepted for selection or election on the platform, the software would need to be verified for its acceptability or feasibility. The verification may be performed internally by the platform or by other parties.

In order to facilitate more efficient verification, more efficient selection, and/or flexible combination, the components are to be submitted in modular forms. For example, resource components are to be submitted as resource modules, to be accepted as resource modules, and to be selected as resource modules. For example, software components are to be submitted as software modules, to be accepted as software modules, and to be selected as software modules. In order for selected software modules to be more easily incorporated and assembled with other software components, the software modules are to conform to a set of standards, for example, parameter standards, dimension standards, input/output standards, etc. Likewise, in order for selected resource modules to be more easily incorporated and assembled with other resource components, a resource module is to conform to a set of standards, for example, parameter standards, dimension standards, resolution standards, etc.

To enhance compatibility among various components, the platform may make available a set of standards in order to facilitate more efficient and more expeditious development, assembly and conversion. For example, the platform may make available software development kits (SDK) to software vendors to facilitate more efficient software development and enhanced compatibility among software components. An example software development kit may include standard software templates carrying standard parameters or parameter ranges. The standard software may be written in a standard language such as C++ or Lua, which are standard computer software languages commonly used in the gaming machine industries.

In order to facilitate or attract contribution of component by various vendors, the electronic platform provides a user interface to facilitate submissions of components, and provides instructions, guidelines, standards and specifications for contributors to follow.

Upon receipt of submissions, the platform, or more specifically the computer of the platform, would operate to examine whether the submitted component conforms with the instructions, guidelines, standards and specifications, for example, through execution of an executable files (TGG executable file) under an operating system environment (for example, Linux environment). For example, the computer of the platform will load submitted script, graphics, audio or text materials, to connect to the game logic server, to activate and update a game UI in order to examine and verify conformity of a submitted component.

When outcome of examination is satisfactory, the submitted component is classified as an “accepted” or “approved” component for user selections. The “accepted” or “approved” component will be stored and accessible for selection and election through the computer operated electronic platform (“TGG platform”).

Referring to FIG. 3D, example deployments of resources on the display screen of an example slot machine are shown. For example, graphics are deployed on various region of the screen of the example slot machine, animation effects are deployed on various region of the screen of the example slot machine. User visible graphical interfaces are deployed on various region of the screen of the example slot machine.

The deployment and disposition of the various graphics, animation effects and user interfaces are according to standards preset by the platform, for example, according to an example template. In this example, the platform provides contributors or potential contributor with an example template and relevant information and parameters to enable contributor to submit contributions which conform to the standards preset by the platform. A contributor who would like to submit graphics for consideration for adaptation by users to adapt as display graphics on reels of a slot machine would need to submit graphics in conformity with various criteria and parameters set by the template. For example, the submitted graphics would need to conform with the various dimensional and spacing criteria to be acceptable.

Likewise, a contributor who would like to submit graphics for consideration for selected adaptation by users to adapt as display graphics on a jackpot screen would need to submit graphics in conformity with various criteria and parameters set by a jackpot graphic template (not shown).

Likewise, a contributor who would like to submit jackpot algorithm for selected adaptation as a jackpot system on a slot machine would need to conform with pre-set software requirements, parameters and input/output means to be approvable.

The example land-based machine of FIG. 3B comprises the example software portion and the hardware portion. The example machine comprises an upper screen, a main screen, a power supply, a bill validator, a button panel, a belly door key, a speaker, a printer and a tower light. For example, the graphics of FIG. 3D are displayed on the main screen, which is for example, an LCD display, to simulate the screen of a land-based slot machine. When a jackpot is scored, the tower light will be lit and rewards pour out to the belly door, as an example.

Referring to FIG. 1, a plurality of modules is stored in the non-volatile storage region of the machine. The plurality of modules is classified into three types of game components, namely, a first type (Modules 1) which is of the Game Server type, a second type (Modules 2) which is of the UI Module type, and a third type (Modules 3) which is of the Platform type.

A Game Server, also known as Game Control, contains computer readable or computer executable instructions relating to and defining game logic and game math. In some examples, a game logic may be formed as a game logic module and a game math module.

An UI Module, also known as a resource module or library module, contains computer readable or computer executable instructions as well as data files relating to human perceivable signals for output to machine-to-user interfaces such as display screens, speakers, seats, etc.

A Platform module, also known as a gaming machine operating system (“GMOS”) module, contains computer readable or computer executable instructions as well as data files relating to general operations of a gaming machine. GMOS includes, for example, computer readable or computer executable instructions for connection of the game engine modules, administrative modules of the gaming machine.

Components of the Game Server and the UI Module when integrated, that is, connected or combined, by the Platform cooperate to form a Game Engine. When the Platform executes instructions of the Game Engine, the Platform is to deliver human perceivable signals to a machine-to-user interface to invite a user to participate in a game by operating a user-controlled user interface to send responsive signs to act or react. The Platform, on receipt of the responsive signals originated from a user-to-machine user interface, is to execute stored instructions to send instructions to the Game Engine and to commence gaming interaction with a user. The user, on receipt of human perceivable signals from the Platform, will act or react by operating a user-to-machine user interface to enter into game interaction with the Platform. The human perceivable signals to a machine-to-user interface are generated the Platform by sending commands to the Game Server and the Game Server then sends message to the UI module to procure the human perceivable signals.

In example embodiments, a plurality of modules of the first type (Game Server type) and/or a plurality of modules of the second type (UI Module type) are stored in the non-volatile data storage region of the machine. The Platform, on executing stored a set of specific gaming instructions to commence a game, according to the stored platform instructions, is to select a Game Server module from the plurality of available Game Server modules and to select an UI module from the available UI modules and to integrate the modules and to execute as an integrated Game Engine.

On running a game, the Platform may deliver a first type of messages to the Gamer Server. The first type of messages is an instruction-type message.

The Game Server in response to messages from the Platform is to deliver a second type of messages to the UI module. The second type of messages is an instruction-type message.

The UI module in response to instruction messages from the Game Server is to send a third type of messages to the Game Server. The third type of messages is a feedback-type or response-type message.

The Game Server in response to instruction messages from the Platform is to send a fourth type of messages to the Platform. The fourth type of messages is a feedback-type or response-type message.

The Game Server in response to feedback messages from the Platform is to send a fifth type of messages to the Platform. The fifth type of messages is a feedback-type or response-type message.

While the present disclosure is with reference to example embodiments, persons skilled in the art would appreciate that the embodiments are non-restrictive examples and do not limit the scope of disclosure.

1. A gaming apparatus comprising a controller, a video display device, a user control interface device, a data storage device and a communication frontend device; wherein the controller is to execute stored instructions to devise a scene or a series of scenes on the video display device to invite a user to act or react, and the user is to act or react by operating the user control interface device to send a responsive signal or responsive signals to the controller; wherein the controller is to detect and process the responsive signal and to evaluate responsive performance of the user based on the received responsive signal and the stored instructions; wherein the stored instructions are resident in a first module which is control module, and data for forming the scene are resident in a second module which is a contents module; and wherein the controller is to communicate with the control module to execute the stored instructions and to communicate with the contents module to obtain data for forming the scene, and wherein the controller is to communicate with the contents module through the control module as a necessary intermediary.

2. The gaming apparatus according to claim 1, wherein the first module comprises a logic portion, and the logic portion contains stored instructions defining rules for detecting and evaluating a received responsive signal, and rules for evaluating responsive performance based on the received responsive signal and the stored instructions.

3. The gaming apparatus according to claim 2, wherein the logic portion comprises instructions defining rules of game flow and game logic, wherein the game logic comprises instructions defining game flow and instructions defining possible outcomes on reaching a specific stage or on receiving a responsive signal.

4. The gaming apparatus according to claim 3, wherein the first module comprises a math portion, and the math portion contains instructions defining mathematical relations associated with the game flow and game logic.

5. The gaming apparatus according to claim 2, wherein the second module comprises instructions to facilitate generation of human perceivable signals for delivery to a machine-user interface for perception by a user operating the user control interface device, the machine-user interface including the video display device.

6. The gaming apparatus according to claim 5, wherein the second module comprises stored instruction files, data files and data links, wherein the controller is to access the data files and or the data links to form the human perceivable signals and to deliver the human perceivable signals to the machine-user interfacing device.

7. The gaming apparatus according to claim 6, wherein the controller is to access the data files and the data links through instructions stored in the first module, and wherein the data files contain data for forming animated graphical scenes and signs.

8. The gaming apparatus according to claim 6, wherein the controller is to execute the instruction files in the second module to generate human perceivable signals, and wherein the controller is to send instructions to the first module to execute the instruction files stored in the second module.

9. The gaming apparatus according to claim 1, wherein the first module and the second module are to communicate using a first type of communication protocol and the controller and the first module are to communicate using a second type of communication protocol different to the first type.

10. The gaming apparatus according to claim 1, wherein the first module is one of a plurality of control modules stored in the data storage device, and the second module is one of a plurality of contents modules stored in the data storage device; and wherein the controller is to select the first module from the plurality of control modules, to select the second module from the plurality of contents modules, to connect the first module and the second module, and to execute instructions stored in the first module to run a computer-controlled game.

11. The gaming apparatus according to claim 10, wherein the controller is to execute stored platform instructions to select the first module from the plurality of control modules, to select the second module from the plurality of contents modules, and to connect the first module and the second module; and wherein the stored instructions are contained in a platform module which is not part of the first module.

12. The gaming apparatus according to claim 11, wherein the first module comprises a plurality of essential communication interfaces for facilitating essential communication with the second module and the controller, wherein the second module comprises a plurality of essential communication interfaces for facilitating essential communication with the first module; and wherein the essential communication interfaces are to facilitate inter-module data communications.

13. The gaming apparatus according to claim 12, wherein the first module is to send a first type and a second type of messages, the first type being an instruction-type message for sending to the second module, and the second type being a feedback-type message for sending to the controller.

14. The gaming apparatus according to claim 13, wherein the second module is to send a feedback-type message to the first module to acknowledge receipt of an instruction-type message from the first module.

15. The gaming apparatus according to claim 12, wherein the controller is to send a first type and a second type of messages, the first type being an instruction-type message for sending to the first module, and the second type being a feedback-type message for sending to the first module.

16. The gaming apparatus according to claim 12, wherein the first module is identifiable has a first identification and the second module has a second identification, and wherein the first module contains no reference to the second identification and the second module contains no reference to the first identification.

17. The gaming apparatus according to claim 12, wherein the second module comprises instructions to facilitate generation of human perceivable signals for delivery to a machine-user interface as human perceivable information for perception by a user operating the user control interface device, the machine-user interface including the video display device; wherein the controller on execution of stored instructions of the first module are to generate a set of human perceivable data; and wherein the second module is to output the human perceivable data and to superimpose the human perceivable data on the human perceivable information.

18. A method of operating a computer-based gaming machine, the machine comprising a controller, a video display device, a user control interface device, a data storage device and a communication frontend device;
wherein the method comprises the controller executing stored instructions to install a first module and a second module on the data storage device, to connect the first and second modules to form a set of game instructions, and to execute the set of game instructions; wherein the game instructions are resident in the first module which is control module, and data for forming the scene are resident in the second module which is a contents module;
wherein the method comprises the controller executing stored instructions to communicate with the control module to execute the stored instructions, and to communicate with the contents module to obtain data for forming the scene, and wherein the controller is to communicate with the contents module through the control module as a necessary intermediary; and
wherein the method further comprises the controller executing the game instructions:
to devise a scene or a series of scenes on the video display device to invite a user to act or react,
to receive responsive signal or responsive signals, to process received responsive signal or receive responsive signals, and
to evaluate responsive performance based on the received responsive signal or the receive responsive signals and the stored instructions, the responsive signal or responsive signals being sent by the user control interface device to the controller.
